(19) United States
(12) Patent Application Publication
(10) Pub. No.: US 2009/0117857 A1
(43) Pub. Date: May 7, 2009

(54) FM radio devices determining preferred inactive FM radio channel for communication

(75) Inventor: Scott Bibaud, Santa Ana, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/959,514

(22) Filed: Dec. 19, 2007

Related U.S. Application Data
(60) Provisional application No. 60/984,747, filed on Nov. 2, 2007.

(51) Int. Cl. H04B 1/40; H04B 1/38

(52) U.S. Cl. 455/77; 375/219

(57) ABSTRACT

Radio devices that are able to communicate with each other using frequencies within the FM radio spectrum are described. One or both of the radio devices identifies inactive FM radio channels within the FM radio spectrum on which no signal is present and selects one of the inactive FM radio channels to communicate with each other.

### CROSS REFERENCE TO RELATED PATENTS

This U.S. application for patent claims the benefit of the filing date of U.S. Provisional Patent Application entitled, FM RADIO DEVICES DETERMINING PREFERRED INACTIVE FM RADIO CHANNEL FOR COMMUNICATION, Attorney Docket No. BP6428, having Ser. No. 60/984,747, filed on Nov. 2, 2007, which is incorporated herein by reference for all purposes.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention is related generally to frequency modulated (FM) audio systems, and more particularly to communication of data using FM communication links.

2. Description of Related Art

Conventional radio devices operate on fixed radio frequency (RF) channels. In the U.S., these channels are regulated and licensed for specific purposes by the Federal Communications Commission (FCC). For example, the frequency band from 535 kilohertz (kHz) to 1.7 megahertz (MHz) is designated for AM broadcast radio, while the frequency band from 88 MHz to 108 MHz is designated for FM broadcast radio. Within any particular region of the U.S., there may be one or more radio stations broadcasting within the FM frequency band. The FCC designates a particular FM radio channel to each radio station, so that no two radio stations are broadcasting on the same radio channel within the same region.

To tune a radio device to a particular broadcasting radio station, either a user can select the desired radio channel on the radio device or the radio device can scan through the FM frequency band until the desired radio channel is reached. There are a wide variety of scan configurations that vary from one radio device to another. For example, some radio devices have scan features that allow the radio to progress through a routine of pre-programmed channels. Other radio devices may facilitate scanning through all frequencies within a particular frequency band. Regardless of the type of configuration, all scanners operate to automatically tune, or scan, two or more discrete frequencies, stopping when they find a signal on one of them.

Outside of the broadcast spectrum, scanners are often used to monitor emergency services and within two-way radio devices to search for a channel with a valid transmission. For example, a scanner may be implemented within a two-way radio device that uses a simplex channel system, in which a single channel is used for transmit and receive, to identify the desired channel for communication. Likewise, a scanner may be implemented within a two-way radio device that uses a duplex channel system, in which different channels are used for transmit and receive, to identify the correct transmit and receive channels.

In trunked non-broadcast radio systems, the system automatically selects the channel on which two or more radio devices will communicate. As such, scanning devices are not typically found in radio devices that operate in trunked radio systems. Instead, in trunked radio systems, there is usually a protocol that defines the relationship between the radio devices and the radio backbone that supports them. This protocol enables automatic channel assignment and makes arrangements for handshaking and connections between the radio devices.

However, in locations that do not provide trunked radio service, parties may not be able to communicate with each other using traditional trunked radio devices, since scanners are not normally included in such radio devices. If the parties are a sufficient distance from each other such that short-range wireless communication protocols, such as Bluetooth, are not possible, unless non-trunked two-way radio devices with scanners are available, the parties may not have a viable option for communicating with each other. In addition, even in locations that do provide trunked radio service, there may be congestion or interference in the trunked radio service that prevents the parties from effectively communicating with each other. Therefore, a need exists for an alternate form of wireless radio communication.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram illustrating a communication system that includes FM radio devices capable of communicating with each other using frequencies within the FM radio spectrum in accordance with the present invention;

FIG. 2 illustrates the FM radio spectrum in accordance with the present invention;

FIG. 3 is a schematic block diagram illustrating an exemplary FM radio device in accordance with the present invention;

FIG. 4 is a logic diagram of a method for establishing communication between FM radio devices using frequencies within the FM radio spectrum in accordance with the present invention; and

FIG. 5 is a logic diagram of a method for selecting an FM radio channel within the FM radio spectrum for communication between FM radio devices in accordance with the present invention.

### DETAILED DESCRIPTION OF THE INVENTION

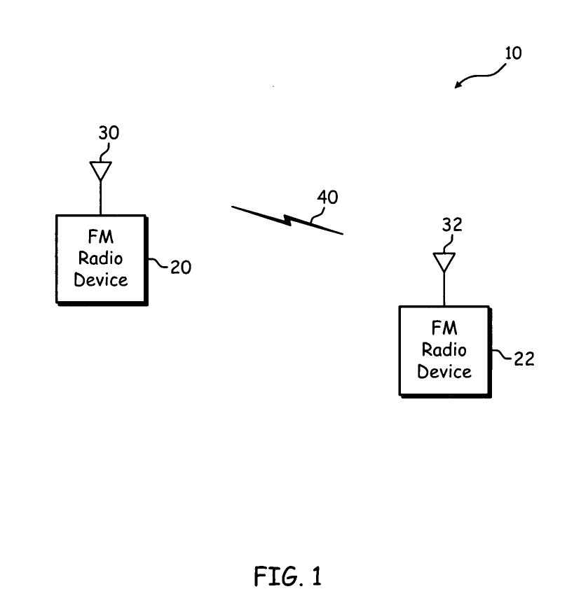

FIG. 1 is a schematic block diagram illustrating a communication system 10 that includes FM radio devices 20 and 22 capable of communicating with each other using frequencies within the FM radio spectrum in accordance with the present invention. The radio devices 20 and 22 may be, for example, car radios, portable radios, cellular telephones incorporating FM radio devices (radio/cell phone) and/or other wireless devices that include FM radio devices.

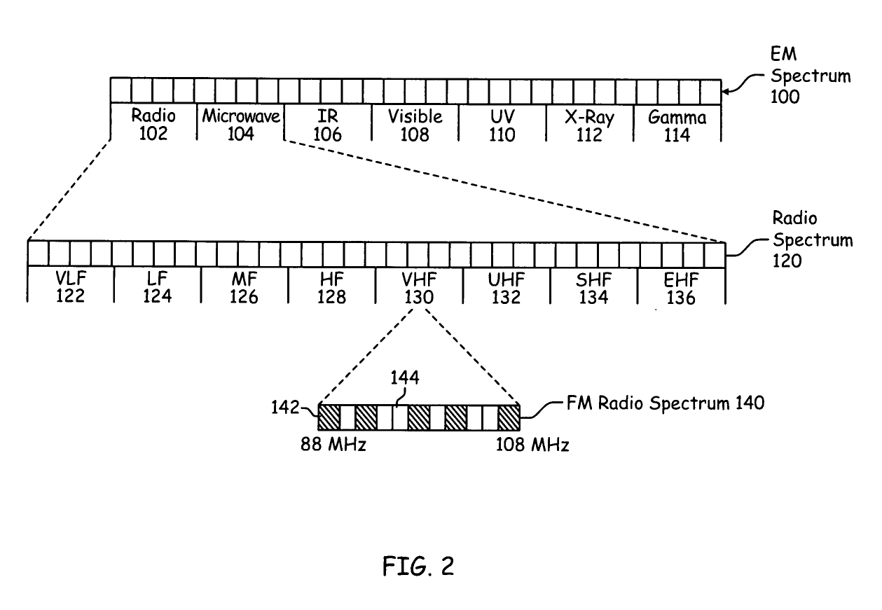

Each of the radio devices 20 and 22 is operable to transmit and receive FM radio signals within the FM frequency spectrum on one or more FM radio frequencies over a radio link 40 via respective antennas 30 and 32. As shown in FIG. 2, the FM frequency spectrum 140 includes a portion of the electromagnetic (EM) spectrum 100 between 88 MHz and 108 MHz. As is well-known, the EM spectrum 100 is commonly characterized according to the particular frequency of radiation. Radio waves 102 and microwaves 104 are low frequency compared to infrared 106, visible 108, ultraviolet 110, X-ray 112 and gamma rays 114. The low-frequency portion, commonly referred to as the radio spectrum 120, of the EM spectrum 100 is used for communication.

The Federal Communications Commission (FCC) is the governmental entity in the U.S. that determines who is able to use which frequency bands for which purposes. Within the radio spectrum 120, the very low frequency (VLF) 122 and low frequency (LF) 124 portions of the radio spectrum 120 have been allocated fore use primarily with communication beneath the surface, such as communication with submarines. Frequencies within the medium frequency (MF) portion 126 of the radio spectrum 120 are used for AM radio, frequencies within the high frequency (HF) portion 128 of the radio spectrum 120 are used for short wave radio, while frequencies within the very high frequency (VHF) portion 130 of the radio spectrum 120 are used for television and FM radio. The other portions, ultra high frequency (UHF) 132, super high frequency (SHF) 134 and extremely high frequency (EHF) 136 are used for other purposes as well, such as additional television stations, cell phones, air traffic control and Global Positioning System (GPS). Thus, as used herein, the term FM radio frequency and FM radio channel refers to frequencies within the FM radio spectrum 140 between 88 MHz and 108 MHz.

Referring again to FIG. 1, as mentioned above, in the U.S., FM radio stations are allocated respective FM channels, each containing 200 kHz of bandwidth around the carrier frequency (in Europe, it is 100 kHz). To avoid interference with nearby FM radio stations, the radio devices 20 and 22 communicate on FM radio channels that are inactive in the region that the radio devices 20 and 22 are located. That is, the radio devices 20 and 22 communicate using FM radio channels that are not allocated to any radio station within the area and on which no signal is currently present.

In one embodiment, the radio devices 20 and 22 are able to analyze the FM frequency band to identify the inactive FM radio channels therein and to select one of the inactive FM radio channels on which to establish communication with each other. For example, one or both of the radio devices 20 and 22 may include a scanner capable of scanning the FM frequency band to identify the inactive FM radio channels. In addition, one or both of the radio devices 20 and 22 may further be able to measure the interference on one or more of the inactive FM radio channels and to select the inactive FM radio channel on which to initiate communication based on the measured interferences. As a result, the radio devices 20 and 22 can communicate on an inactive FM radio channel that has an acceptable level of interference.

In another embodiment, the radio devices 20 and 22 have access to FM radio station information identifying the frequency bands that are allocated to FM radio stations within the geographical area that the radio devices 20 and 22 are currently located, and the radio devices 20 and 22 are able to select an FM radio channel that is not allocated to any FM radio station to communicate with each other. For example, the FM radio station information may be stored within the radio devices 20 and 22 or downloaded to the radio devices 20 and 22 through a wireless network serving the radio devices 20 and 22 upon entering a particular geographical area. If the FM radio station information is stored within the radio devices 20 and 22, the radio devices 20 and 22 may further be able to determine their current geographical location using any available locating technique, such as the Global Positioning System (GPS) or a network-based locating technique.

Once communication between the radio devices 20 and 22 is established over an inactive FM radio channel, the radio devices 20 and 22 may communicate audio data (e.g., speech) and/or digital data, such as numeric messages and/or text messages, over the FM radio channel. In addition, the radio devices 20 and 22 may employ modulation schemes, such as frequency shift keying, audio frequency shift keying or quadrature shift keying to encode the data. Thus, in an exemplary embodiment, each radio device 20 and 22 includes a built-in transceiver (transmitter and receiver) for modulating/demodulating information (data or speech) bits into a format that comports with a particular communication standard utilized by the radio devices 20 and 22. There are a number of well-defined wireless communication standards (e.g., IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof) that could facilitate such wireless communication between the radio devices 20 and 22.

In a further embodiment, the radio devices 20 and 22 may utilize an embedding technique to embed digital data within an audio signal that is transmitted over the FM radio channel. For example, the radio devices 20 and 22 may use a technique similar to the Radio Data System (RDS). RDS is a separate radio signal (subcarrier) that fits within the station's frequency allocation. The RDS subcarrier carries digital information at a frequency of 57 kHz with a data rate of 1187.5 bits per second. The RDS data is transmitted simultaneously with the standard audio signal. More specifically, the RDS operates by adding data to the baseband signal that is used to modulate the radio frequency carrier. The RDS data is placed above the audio signal on a 57 kHz RDS subcarrier that is locked onto the pilot tone. The RDS subcarrier is phase modulated, typically using a form of modulation called Quadrature Phase Shift Keying (QPSK). By phase modulating the RDS data and operating the RDS subcarrier at a harmonic of the pilot tone, potential interference with the audio signal is reduced.

In operation, when two radio devices 20 and 22 desire to communicate with each other over an FM radio channel, the radio devices 20 and 22 select and agree on a particular inactive FM radio channel to communicate on. In one embodiment, the radio devices 20 and 22 automatically select and agree on the inactive FM radio channel. For example, one of the radio devices (e.g., radio device 20) may select the inactive FM radio channel and communicate the identity of the selected inactive FM radio channel to the other radio device 22 over a dedicated control channel, which may one of one or more predetermined FM radio channels. As an example, there may be several FM radio channels that are known to not be allocated in certain geographical areas (e.g., a state within the U.S.) or who are known to not be allocated across the majority of a particular geographical area (e.g., the U.S.), and one or more of these may be designated as potential control channels for the radio devices 20 and 22.

In another embodiment, a user of one of the radio devices (e.g., radio device 22) is apprised of the selected FM channel by the other radio device 20 and is directed for tune the radio device 22 to the selected FM channel. For example, a user may receive a text message or other message on another wireless device that instructs that user to tune his/her radio device 22 to a particular FM channel. As another example, one of the radio devices 22 may be a car audio system within an automobile and the other radio device 20 may be a cell phone within the automobile. The cell phone 20 may display a message to the user instructing the user to tune the car audio system 22 to a particular inactive FM radio channel in order for the cell phone 20 to communicate data, such as navigation data or other type of data, to the car audio system 22.

Once the communication connection is established over a selected FM radio channel, radio signals containing audio and/or digital data can be communicated between the radio devices 20 and 22. If a received FM radio signal includes digital data, the radio device 20, 22 demodulates the digital data, and then can display the digital data on a display of the radio device 20, 22. For example, if a car audio system 22 is currently tuned to an inactive FM radio channel containing digital data identifying the status of traffic within the geographical area, the display on the car audio system 22 can display the current traffic status on a display of the car audio system 22. To prevent unauthorized listeners from tuning to the same FM radio channel and “listening in”, the audio and/or digital data can be encrypted to protect the confidentiality of the data and to verify the integrity and authenticity of the data.

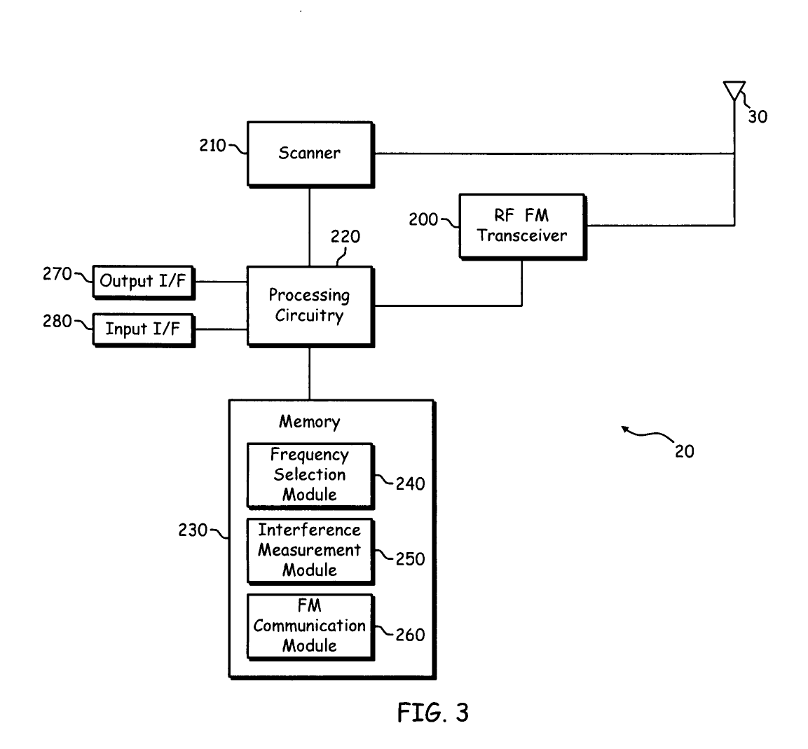

FIG. 3 is a schematic block diagram an exemplary radio device 20 in accordance with the present invention. The radio device 20 includes an antenna 30, an RF FM radio transceiver 200, processing circuitry 220, a memory 230 and a scanner 210. The scanner 210 may be a separate or stand-alone device or may be integrated within the RF FM transceiver 200. The radio device 20 may further include an optional network transceiver and associated antenna (not shown) for communicating with a wireless (cellular) communication network and/or an optional Global Positioning System (GPS) receiver (not shown) that is capable of positioning the radio device 20 using a GPS technique. In embodiments in which the radio device 20 includes the network transceiver, the transceiver may be built-in, incorporated as part of the RF FM transceiver 200 or an externally coupled component.

The processing circuitry 220 is communicatively coupled to the memory 230 and to the scanner 210. The memory 230 stores, and the processing circuitry 220 executes, operational instructions corresponding to at least some of the functions illustrated herein. For example, in one embodiment, the memory 230 maintains a frequency selection module 240, an interference measurement module 250 and an FM communication module 260. The frequency selection module 240 includes instructions executable by the processing circuitry 220 for selecting an inactive FM radio channel on which to communicate with another radio device. The frequency selection module 240 may operate in conjunction with the scanner 210 to identify the inactive FM radio channels. For example, upon executing the frequency selection module 240, the processing circuitry 220 may initiate the scanner 210 to scan the FM radio spectrum to identify the inactive FM radio channels and provide a list of inactive FM radio channels to the frequency selection module 240. In other embodiments, the frequency selection module 240 operates in response to user input or in response to FM radio station information (not shown) stored in memory 230 to select a particular inactive FM radio channel.

The interference measurement module 250 includes instructions executable by the processing circuitry 220 for measuring signal quality characteristics associated with one or more identified inactive FM radio channels. The interference measurement module 250 operates in conjunction with the frequency selection module 240 to assist the frequency selection module 240 in selecting a particular inactive FM radio channel. For example, the frequency selection module 240 can create a list of one or more inactive FM radio channels and provide this list to the interference measurement module 250 for measuring the interference on each of the inactive FM radio channels in the list. Based on the measured interference on each of the inactive FM radio channels, as determined by the interference measurement module 250, the frequency selection module 240 can select the inactive FM radio channel with the minimum interference or an acceptable level of interference. The FM communication module 260 includes instructions executable by the processing circuitry 220 to establish a communication connection with another radio device on the selected inactive FM radio channel.

The processing circuitry 220 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 230 may be a single memory device or a plurality of memory devices. Such a memory device may be a read-only memory, random access memory, volatile memory, non-volatile memory, static memory, dynamic memory, flash memory, and/or any device that stores digital information. Note that when the processing circuitry 220 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In addition, as one of average skill in the art will appreciate, the radio device of FIG. 3 may be implemented using one or more integrated circuits. For example, the transceiver 200 may be implemented on a first integrated circuit, while the processing circuitry 220 is implemented on a second integrated circuit, and the remaining components, i.e., the scanner 210 may be implemented on a third integrated circuit. As an alternate example, the transceiver 200 and scanner 210 may be implemented on a first integrated circuit and the processing circuitry 220 may be implemented on a second integrated circuit. As yet another alternate example, the transceiver 200, scanner 210 and processing circuitry 220 may all be implemented on a single integrated circuit. Further, memory 230 may be implemented on the same integrated circuit as processing circuitry 220 or on a different integrated circuit.

The radio device 20 further includes an input interface 280 and an output interface 270, each communicatively coupled to the processing circuitry 220. The output interface 270 provides an interface to one or more output devices, such as a display, speakers, etc. The input interface 280 provides one or more interfaces for receiving user input via one or more input devices (e.g., mouse, keyboard, touch pad, touch screen, etc.) from a user operating the radio device 20. For example, such user input can include a request to tune the radio device 20 to a particular selected FM radio channel or to initiate communication with another radio device.

In operation, to establish communication with another radio device, the radio device 20 initiates the frequency selection module 240 to select an inactive FM radio channel for the communication. In one embodiment, the frequency selection module 240 initiates the scanner 210 to create a list of inactive FM radio channels. In another embodiment, the frequency selection module 240 accesses a list of inactive FM radio channels that is either downloaded to the radio device 20 or maintained by the radio device 20. The frequency selection module 240 further provides the list of inactive FM radio channels to the interference measurement module 250, which measures the interference on each potential inactive FM radio channel and provides the interference measurements to the frequency selection module 240 for use by the frequency selection module 240 in selecting the particular inactive FM radio channel for communication. Once the inactive FM radio channel is selected, the FM communication module 260 instructs the RF FM transceiver 200 to tune to the selected inactive FM radio channel for communication with the other radio device. Prior to this, the FM communication module 260 may further communicate the selected inactive FM radio channel to the other radio device via the RF FM transceiver 200 over a dedicated control channel.

During the communication connection, when the radio device 20 receives an FM radio signal via the antenna 30, the antenna 20 provides the FM radio signal to the RF FM transceiver 200, which processes the FM radio signal to demodulate the received FM radio signal and recover the audio data and/or digital data. For example, the RF FM transceiver 200 can include a digital data demodulator that operates to decode the digital data included within the received FM radio signal. In addition, the decoded audio data can be provided to the output I/F 270 for output to speakers, while the decoded digital data can be provided to the output I/F 270 for display on the radio device 20. Likewise, audio data and/or digital data received via input I/F 280 can be modulated and transmitted to the other radio device via RF FM transceiver 200 and antenna 30.

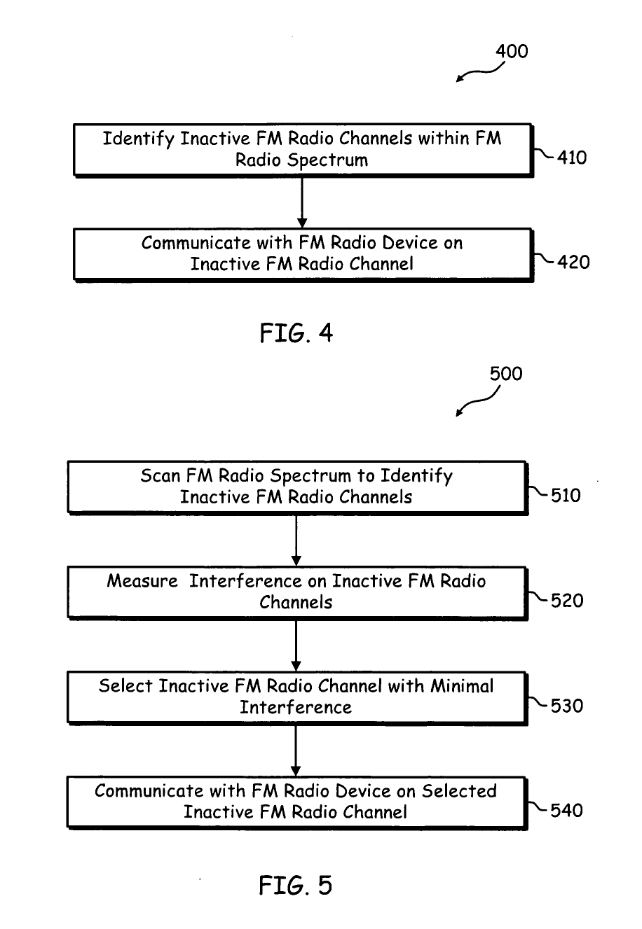

FIG. 4 is a logic diagram of a method 400 for establishing communication between FM radio devices using frequencies within the FM radio spectrum in accordance with the present invention. The process begins at step 410, where inactive FM radio channels including frequencies within the FM radio spectrum are identified. The inactive FM radio channels are channels on which no other FM radio station is currently broadcasting within the geographical area of the FM radio devices and on which no other signal is currently present. Once the inactive FM radio channels are identified, at step 420, one of these inactive FM radio channels is selected for communication between the FM radio devices.

FIG. 5 is a logic diagram of a method 500 for selecting an FM radio channel within the FM radio spectrum for communication between FM radio devices in accordance with the present invention. The process begins at step 510, where the FM radio spectrum between 88 MHz and 108 MHz is scanned to identify all of the inactive FM radio channels within the FM radio spectrum. The process continues at step 520, where the interference on one or more of the inactive FM radio channels is measured, and at step 530, the measured interferences are used to select one of the FM radio channels. For example, the selected FM radio channel may be the FM radio channel with the minimum interference or the first FM radio channel measured that has an acceptable level of interference. The process ends at step 540, where the selected FM radio channel is used for communication between the FM radio devices.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has further been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The preceding discussion has presented a radio device and method of operation thereof. As one of ordinary skill in the art will appreciate, other embodiments may be derived from the teaching of the present invention without deviating from the scope of the claims.

What is claimed is:

1. A radio device, comprising:
a transceiver operable to transmit and receive frequency modulated (FM) radio signals on a plurality of FM radio channels, each including frequencies within the FM radio spectrum between 88 MegaHertz (MH) and 108 MHz; and
processing circuitry coupled to said transceiver and operable to:
identify inactive ones of said FM radio channels, said inactive FM radio channels being ones of said FM radio channels on which no signal is present,
select a selected one of said inactive FM radio channels on which to transmit and receive said radio signals; and
initiate communication with an additional radio device via said transceiver on said selected one of said inactive FM radio channels.

2. The radio device of claim 1, wherein said radio signals include at least one of audio data and digital data.

3. The radio device of claim 2, wherein said processing circuitry operates to add said digital data to a baseband signal that is used to modulate said selected inactive FM radio channel to transmit, via said transceiver, said digital data and said audio data simultaneously on a transmitted one of said radio signals to said additional radio device.

4. The radio device of claim 3, wherein said processing circuitry further operates to decode said digital data within a received one of said radio signals received via said transceiver from said additional radio device.

5. The radio device of claim 1, wherein said processing circuitry is further operable to measure a respective interference present on one or more of said inactive FM radio channels within said FM radio spectrum and to utilize said measured interferences to select said selected one of said inactive FM radio channels.

6. The radio device of claim 5, wherein processing circuitry selects as said selected one of said inactive FM radio channel said one of said inactive FM radio channels having the lowest one of said measured interferences.

7. The radio device of claim 1, further comprising:
a scanning device coupled to said processing circuitry and operable to scan said FM radio channels within the FM radio spectrum to identify said inactive FM radio channels.

8. The radio device of claim 7, wherein said scanning device is implemented within said transceiver.

9. The radio device of claim 7, wherein said scanning device is implemented using said processing circuitry and said transceiver.

10. The radio device of claim 1, wherein said processing circuitry is further operable to communicate said selected one of said inactive FM radio channels to said additional radio device.

11. The radio device of claim 10, wherein said processing circuitry operates to communicate said selected one of said inactive FM radio channels to said additional radio device by initiating transmission of said selected one of said inactive FM radio channels on a dedicated control channel of said FM radio channels.

12. The radio device of claim 10, wherein said processing circuitry operates to provide an identity of said selected one of said inactive FM radio channels to a user of said radio device via an output user interface.

13. The radio device of claim 1, wherein said processing circuitry operates to select said selected one of said inactive FM radio channels based on input from a user of said radio device.

14. The radio device of claim 1, wherein said processing circuitry operates to select said selected one of said inactive FM radio channels based on receipt of an identity of said inactive FM radio channel from said additional radio device via a dedicated control channel of said FM radio channels.

15. A method for establishing communication between radio devices using FM radio channels including frequencies within the FM radio spectrum between 88 MHz and 108 MHz, said method comprising:
identifying inactive ones of said FM radio channels, said inactive FM radio channels being ones of said FM radio channels on which no signal is present;
selecting a selected one of said inactive FM radio channels on which to transmit and receive radio signals between said radio devices; and
initiating communication between said radio devices on said selected one of said inactive FM radio channels.

16. The method of claim 15, wherein said radio signals include at least one of audio data and digital data.

17. The method of claim 16, further comprising:
adding said digital data to a baseband signal that is used to modulate said selected inactive FM radio channel to transmit said digital data and said audio data simultaneously on a transmitted one of said radio signals.

18. The method of claim 15, wherein said selecting further comprises:
measuring a respective interference present on one or more of said inactive FM radio channels within said FM radio spectrum; and
utilizing said measured interferences to select said selected one of said inactive FM radio channels.

19. The method of claim 15, wherein said identifying further comprises:
scanning said FM radio channels within the FM radio spectrum to identify said inactive frequencies.

20. The method of claim 15, wherein said initiating further comprises:
communicating said selected one of said inactive FM radio channels between said radio devices.
